(19) United States
(12) Patent Application Publication
(10) Pub. No.: US 2025/0370724 A1
(43) Pub. Date: Dec. 4, 2025

(54) Model-Based Algorithm to Embed Generic Safety

(71) Applicants: Pacifique Munezero, Fredericksburg, VA (US); Jon W. Frederick, Fredericksburg, VA (US); Rani A. Kady, Spotsylvania, VA (US); Emily E. Ochsenknecht, Fredericksburg, VA (US); Deztany Jackson, Fredericksburg, VA (US); Timothy J. Bailey, Spotsylvania, VA (US)

(72) Inventors: Pacifique Munezero, Fredericksburg, VA (US); Jon W. Frederick, Fredericksburg, VA (US); Rani A. Kady, Spotsylvania, VA (US); Emily E. Ochsenknecht, Fredericksburg, VA (US); Deztany Jackson, Fredericksburg, VA (US); Timothy J. Bailey, Spotsylvania, VA (US)

(73) Assignee: United States of America, as represented by the Secretary of the Navy, Arlington, VA (US)

(21) Appl. No.: 18/677,037

(22) Filed: May 29, 2024

(51) Int. Cl. G06F 8/35

(52) U.S. Cl. CPC G06F 8/35

(57) ABSTRACT

A method for analyzing system safety requirements. The method includes parsing a plurality system and/or software specific requirements, and filtering the plurality system and/or software specific requirements using a generic system safety requirements (GSSR) model to generate a matched generic safety requirement in pre-set tables.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The present disclosure relates to the field of model-based systems engineering (MBSE), specifically the integration and application of safety requirements within system modeling languages.

The present disclosure addresses several challenges. One challenge is the arcane language of safety requirements. Each requirement is two or three sentences, making it difficult for non-safety engineers to comprehend. The arcane language impedes implementation, verification, and validation in later phases of system development. Another challenge is safety specific expressions. While these expressions may be self-explanatory to safety engineers, they are not intuitive to design engineers. The adjudication process between safety engineers and design engineers creates delays. A further challenge is that not all generic requirements apply to all software or systems because systems vary in size, shape, use, and complexity. For example, a program using statements such as “Design ABC system in accordance to design standard XYZ”. Tailoring requirements early in the design phase provides cost savings by alleviating the inconvenience of using the “blanket” approach.

The task of specifying the list of applicable generic safety requirements supports the objective of safe system design. The Department Of Defense Standard Practice System Safety 882E and the Joint Software System Safety engineering handbook recommend the task. Old methods of execution require a safety engineer to search multiple Word or PDF published lists of generic safety requirements published by several agencies and institutions to identify applicable generic requirements. System safety must then assess each item for applicability, compliance, or non-compliance and document evidence. The current process presents challenges related to interpretation, time consumption and cost prohibitive methods.

FIG. 1 shows a method describing the current state of the art. In step 1, a user gathers the inputs. Typically, the user is a systems safety engineer (SSE). The inputs may include known requirements, hazards, capabilities, and relevant military and commercial specifications, standards and handbooks. In step 2, the method searches PDF files and word files to determine if any generic requirements are applicable to the system/software under development. If the method determines that there are no applicable requirements, the method skips to step 5. However, if the method determines that there are applicable requirements, the method moves to step 3. In step 3, the method identifies generic requirements applicable to the system under development. In step 4, Portable Document Format (PDF) and Microsoft Word documents are copy and pasted into separate table format. In step 5, the method allocates an SSE developed list of Generic System Safety Requirements (GSSRs) to applicable systems/sub-systems. In step 6, draft requirements are prepared in table form to submit to the Lead System Engineer (LSE). In step 7, the LSE and SSE team reviews the draft requirements. In step 8, adjudication meetings are set. System/sub-system specific System Engineers review the GSSRs and provide modifications to wording and applicability. In step 9, an adjudication meeting is scheduled. In step 10, the adjudication committee reaches an agreement on which GSSRs to incorporate. In step 11, the adjudication committee finalizes the list of GSSRs and discusses verification methods. In step 12, the GSSRs are determined to be valid and verifiable. In step 13, if the GSSRs are not valid and verifiable, new GSSRs are proposed. In step 14, the new GSSRs from step 13 are evaluated. In step 15, GSSRs that are not accepted are documented for follow-on tasks. In step 16, if the GSSRs are valid and verifiable, the GSSR(s) are entered into the compliance matrix. The GSSR(s) are entered by copy and documented in excel or word.

The output of the method includes: 1) Input to safety requirements hazard analysis worksheet and safety verification matrix; 2) updated generic safety requirements compliance matrices; 3) Input to lowest level requirements documents; 3) Updated design precepts; and 4) Updated safety review board technical data package input.

This current method has a few problems. These problems include a reliance on PDF and excel files, a lack of generic safety requirements which requires a two-step process in which the user first identifies the generic system requirements and, second, entering them into the system manually.

### SUMMARY

To support the identification of a generic safety requirement, the present application discloses a custom stereotype with a safety extension generalization. This includes the variables of value type string, value type Boolean and value type enumeration literals in the Systems Modeling Language (SysML).

The integration of Model-Based Systems Engineering (MBSE) safety solutions during system development impacts system design early in the system development. As the implementation of MBSE evolves, there is a sense of urgency to develop and validate MBSE hazard analysis solutions. This approach presents the methodology and results of embedding generic safety requirements in a MBSE environment. The approach identified and integrated Generic Safety Significant Software Requirements (GSSSRs) in a Systems Modeling Language (SysML) using Cameo Systems Modeler. The results include a reusable, platform agnostic, and tailorable model library of approximately 150 GSSSRs and safety coding practices. The results also include a SysML requirements diagram, a glossary with safety specific definitions, and three customized model-based safety reports. Results demonstrate prototype scalability to support requirements other than GSSSRs. The proposed solution provides a framework to document and decompose/allocate requirements to the system under development within a MBSE environment and supports the prioritization of program resources for each requirement. The safety of the warfighter is one of the primary considerations when developing navy capabilities. Accordingly, safety requirements are important in system software design because they describe the needed and necessary conditions to safeguard the warfighter.

The complexity in safety significant systems and the sense of urgency to develop and adapt technology at the speed of need is gaining increasing importance. By order of precedence, design level tasks are categorized as the most impactful because a safe design results in fewer mitigating requirements in later phases of the system acquisition and detailed hazard analysis discover hazard mitigations already embedded in the design. Systems engineering, in conjunction with other cross-functional teams, develops and implements requirements. System Safety Engineering (SSE), a discipline that supports systems engineering, specializes in assessments of system safety risk. Evolutionary developments affecting systems engineering can also be influential with respect to SSE. The task of specifying the list of applicable generic safety requirements is executed by SSE and supports the objective of safe system design by tailoring requirements that have been documented over the years under the heading of lessons learned and best practices to a given development effort. Several individuals, agencies, and institutions have published lists of generic safety requirements for consideration, and the system safety analyst must assess each item for applicability, compliance, or non-compliance. Here, the applicants applied MBSE techniques to support the digital execution of the SSE task of embedding generic requirements in digital model-based systems engineering development efforts and provide model-based reporting capabilities. The applicants selected GSSSRs to demonstrate the approach. The applicants modeled the requirements through SysML as part of the MBSE approach. The rest of this paper presents the methodology, results, discussion, and conclusion.

### Methodology

To leverage the existing body of knowledge, the literature review of published technical documentation included peer reviewed articles, safety technical standards, and MBSE toolkits. The applicants explored requirements and safety analysis with MBSE and found no existing digital library of generic safety requirements that could be leveraged. Moreover, technical conversations using open-ended questions with subject matter experts in safety engineering found that challenges resided in two areas. The first challenge was that non-safety engineers struggled to comprehend requirements expressed with two or three sentences. This challenge impedes implementation, verification, and validation in later phases of system development. The second challenging area was safety specific expressions, which may be self-explanatory to safety engineers, but not intuitive to design engineers. This ambiguity of technical terms extended the duration of adjudication windows between safety engineers and design engineers.

An algorithm, within the scope of this study, is a systematic procedure that produces—in a finite number of steps—the answer to a question or the solution of a problem. Designing the algorithm to embed generic safety requirements leveraged the leading language for MBSE activities, SysML. This language has nine (9) diagram types, each associated with specific relationships and tags in a model. For a discipline specific investigation such as system safety, engineers create stereotypes and tags to support analysis execution. Based on the understudied system problem, the proposed solution needed to include a requirements diagram and a sequence diagram. The selected modeling tool offers the ability to construct a model-based glossary and used to include safety specific definitions to establish a supporting infrastructure for collaboration and communication across stakeholders.

Textual requirements were sampled from paragraphs and the extraction criteria was set to ‘shall’ statements. The SysML requirements diagram at a minimum requires critical specifications of name, text, and ID. This allows the model-based blueprint to provide a draft schema of how the applicants designed the algorithm in the modeling environment. The benefits of this are threefold. First, the algorithm lists the requirements in single sentence statements. Second, the algorithm verifies that each requirement is concise, complete, and non-ambiguous. Third, the algorithm identifies and inserts a list of definitions related to safety to facilitate collaboration and adjudication. Transposing requirements from paragraphs to SysML format dictated the breakdown of each paragraph into single sentences. When multiple requirements are listed in the same category, the algorithm nests requirements property to maintain relationships.

### Results

As discussed in the methodology, the digital model addresses the construction of the algorithm and the task execution in a model-based environment by the algorithm. Therefore, the applicants created a SysML profile to guide the safety analyst in how to document, decompose, and allocate requirements to the system under development within a MBSE environment. Each of the modeling aspects created for purposes within the task of specifying the list of applicable generic safety requirements are contained in this profile. The profile can be shared and loaded within a system model. This provides a system with the necessary stereotypes and formats to guide the safety analyst how to meet process requirements. As seen in FIG. 2 the generic safety requirements profile containment tree is sub-divided into six packages: 1) Navigation, 2) Algorithm Integration, 3) Design, 4) Safety Requirements, 5) Reports, and 6) Custom Requirements Profile.

### Navigation Package

The navigation package describes the purpose and scope of the model to support the execution of the SSE task of embedding generic requirements in digital model-based systems engineering development efforts. This package also lists model contents to orient the user such as Algorithm integration, Generic Software Safety Requirements, Glossary, Applicable Generic Requirements Matrix, and Imposed Generic Requirements.

### Algorithm Integration Package

The first safety artifact generated is the model-based collaboration process to execute the task of embedding generic safety requirements in a system and/or software's development lifecycle. FIG. 3 provides an overview of the process and represents the sequence of activities from both the system design and safety perspectives. The algorithm integration sequence diagram ties the system design or software design cross-functional team, the safety cross functional team, a SysML Model Repository which represents the modeling collaboration platform or cloud-based collaboration environment, and the algorithm composed of formulas and stereotypes embedded in the matrices and tables in this generic safety requirements model. The diagram highlights safety's involvement in the decomposition and allocation of generic safety requirements, the responsible entity of an activity and the destination for the results of an activity. Table 1 expands on the iterative and collaborative nature that emerges from integrating the system and safety life cycle.

Framework for Model-Based Safety Analysis (Bhada 2020) and tailored to generic safety requirements integration in a MBSE environment

TABLE 1
Iterative and Collaborative Model-Based Process Steps

| Step # and Title | Actors | Actions |
|---|---|---|
| 1. Develop System Conceptual | System Design, Safety | The System Design team |
| Design | | provides information related to |
| | | concepts of operations and |
| | | customer needs to safety with |
| | | respect to a given development |
| | | effort. |
| 2. Identify System | System Design, SysML Model | The System Design team |
| Requirements | Repository | provides information related to |
| | | System Requirements, if |
| | | available, in a model with |
| | | respect to a given development |
| | | effort. |
| 3. Identify Intended | System Design, SysML Model | The System Design team |
| Functionality | Repository | provides information related to |
| | | intended functionality, if |
| | | available, in a model with |
| | | respect to a given development |
| | | effort. |
| 4. Evaluate Design and | Safety, SysML Model | The Safety team reviews |
| Functionality | Repository | information in the model. |
| 5. Apply Safety Algorithm to | Safety, Algorithm | The Safety team merges |
| Design | | system model and safety |
| | | algorithm using the project |
| | | usage feature in MBSE toolkit. |
| 6. Generate Applicable | Safety, SysML Model | The Safety team engineer uses |
| Software System Generic | Repository, Algorithm | engineering knowledge and |
| Requirements | | system design to identify |
| | | which requirements trace to |
| | | system attributes under the |
| | | Reports package diagram in |
| | | the Applicable Generic |
| | | Requirements Matrix. The |
| | | Safety team uses the algorithm |
| | | to ensure the system attributes |
| | | are tagged with Safety |
| | | Extension and Utility |
| | | Stereotypes. |
| 7. Evaluate Applicability to | Safety, SysML Model | The Safety team verifies that |
| Development Effort | Repository, Algorithm | the ‘True’ value is checked for |
| | | all identified requirements |
| | | under the Reports package |
| | | diagram in the Imposed |
| | | Generic Requirements Table. |
| | | The Safety team assumes these |
| | | requirements to be applicable |
| | | until the System Design team |
| | | provides the rationale for non- |
| | | applicability. |
| 8. Document Safety Rationale | Safety | The Safety team researches |
| | | programmatic document(s) to |
| | | identify requirements which |
| | | need to be referenced based on |
| | | the development phase. |
| 9. Update Changes to Safety | Safety, SysML Model | The Safety team Principal for |
| Model | Repository | Safety provides rationale for |
| | | applicability and in which |
| | | document requirements need |
| | | to be identified under the |
| | | Reports package diagram in |
| | | the Imposed Generic |
| | | Requirements Table. |
| 10. Generate Imposed Generic | Safety, SysML Model | The Safety team generates and |
| Software System | Repository, Algorithm | forwards a report from the |
| Requirements | | algorithm to the System |
| | | Design team in a digital |
| | | collaboration platform. This is |
| | | an interim report for review to |
| | | support proper requirements |
| | | alignment. |
| 11. Review Imposed Generic | System Design, SysML Model | The System Design accesses |
| Software System Requirements | Repository | imposed requirements and plans |
| | | review and adjudication |
| | | meeting(s). |
| 12. Document Compliance | System Design, Safety | The System Design and Safety |
| | | teams discuss compliance with |
| | | generic requirements and |
| | | glossary terms with respect to |
| | | the development effort. The |
| | | System Design team updates |
| | | information as needed. During |
| | | adjudication, the Safety team |
| | | and the System Design team |
| | | discuss the validity of |
| | | applicability. If a given |
| | | requirement is deemed not |
| | | applicable, the column that had |
| | | been marked as ‘True’ in step 7 is |
| | | reverted back to ‘False’. |
| 13. Generate Applicable Generic | System Design, Safety | The System Design and Safety |
| Requirements Matrix, Imposed | | teams generate reports in the |
| Generic Requirements Table, and | | required formats and maintain |
| Glossary | | them in accordance with the |
| | | established system or software |
| | | configuration management |
| | | process. |
| 14. Embed Generic Software | System Design, SysML Model | The System Design team |
| Systems Requirements in | Repository | completes step and saves |
| Programmatic Documents | | Objective Quality Evidence (OQE) |
| | | in the model. The Custom |
| | | Requirements Profile has a |
| | | repository, coded as a string data |
| | | type, for the rationale data. Input |
| | | from the Design team is saved |
| | | under ‘System Design Evidence - |
| | | Yes’ or ‘System Design Rationale - |
| | | No’ columns in the model for |
| | | compliance or non-compliance |
| | | rationale, respectively. Files can |
| | | be imported back into the SysML |
| | | model to store the added |
| | | information. As a result, any |
| | | changes made to the safety |
| | | artifact by the engineer are |
| | | automatically reflected in the |
| | | SysML model. Examples of |
| | | programmatic documents |
| | | include Software Development |
| | | Plan, Software Requirements, |
| | | and Specifications. The model |
| | | remains a living digital artifact. |
| | | As new information becomes |
| | | available, the model is updated. |
| 15. Tag Embedded Generic | Safety | As the system design evolves, |
| Software System Requirements | | incorporated safety design |
| as Systemic Safety Features | | requirements become embedded |
| | | mitigations that could be utilized |
| | | during subsequent safety hazard |
| | | analyses. The Safety team uses |
| | | the “To Do” column to document |
| | | next steps of tagging once the |
| | | system is designed. |
| 16. Establish Traceability | Safety | The Safety team assesses system |
| Between Design, Generic | | throughout the development |
| Software System Safety | | phase and documents OQE. |
| Requirements and Follow On | | |
| Safety Analyses | | |

### Design Package

The design package is provided as part of the profile to support integration with any SysML based software or system model. This package is purposefully empty to support a program and platform agnostic process.

### Safety Requirements Package

Transposing textual requirements in SysML resulted in a model-based library of 150 generic requirements in tabular and containment map formats. The requirement containment map allows for rapid review, analysis, and creation of relations among the requirements of the selected context. The tabular requirements diagram allows the addition of a glossary of safety-specific terms to ensure consistent usage of terminology in the system or software model and improve communication between team members. Words defined as terms are underlined and are understood to have the same definitions and usages everywhere they appear in the model. FIG. 4 illustrates the transposition of paragraph-based requirements in textual SysML format.

### Reports Package

The reports package contains a dependency matrix and a generic table to facilitate generation of applicable generic requirements and documentation of compliance evidence. The dependency matrix displays the relationship between elements and element properties for a particular scope, element property, or type of element through filtering the unimportant data. Hierarchical columns allow for browsing directly in the created matrix through the model scope and visualization of the required area. A generic table is a diagram with a specific stereotype used to represent the element properties in a table form. It can represent different element types in one table and show all their properties. Table rows represent elements, and columns represent element properties. Digital version and document printouts are available through the report wizard capability in Cameo Systems Modeler to support different types of stakeholders' reviews. FIG. 5 and FIG. 6 illustrate safety reports of applicable generic requirements dependency matrix and imposed generic requirements, respectively.

### Custom Requirements Profile Package

To support the identification of a generic safety requirement, FIG. 7 shows a custom stereotype created with a safety extension generalization. A stereotype creates new model elements derived from existing SysML elements, customized with specific attributes and tagged values. Stereotyped elements, the set of which is known as a Profile, then become the primitive building blocks of the modeling effort.

### Discussion

This project contributes to the investigation into the transition of system safety methodologies to model-based approaches to support the digital transformation of system engineering.

### Agnostic, Portable, and Reusable Solution

The requirements library was constructed as a standalone model. This approach was selected to support an agnostic, portable, and reusable solution. The package diagram of safety requirements containing GSSSRs can be substituted or expanded to support generic requirements other than GSSSRs by using model import or project usage capability and reusing the profile presented in this study. The ability to reuse the generic safety requirements profile is in alignment with the design reuse methodology, which promulgates the use of stereotypes and leverages the principles of MBSE—primarily centralization of system data/information in a digital environment—to improve upon current practices in unplanned/ad-hoc design reuse, which are characterized by unstructured methods (Trujillo 2020).

### Design Decision Making

A model-based matrix addresses the use of diagrams, relationship tracing, and coded analysis to ease and/or automate requirements within the system or software. The matrix and the created stereotypes support the identification and tailoring of generic safety requirements to a specific software or system design effort. In fact, not all generic requirements apply to all software or systems because systems vary in size, shape, use, and complexity. Conversely, not all software or systems require generic requirements. Tailoring requirements early in the design phase provides cost savings by alleviating the inconvenience of using the “blanket” approach. This approach would otherwise require the establishment of the entire list of guidelines or requirements for a Program using statements such as “Design ABC system in accordance to design standard XYZ”.

Presenting this approach in a model-based environment contributes to the body of knowledge in the decision making domain, and further expands the ability to support design decision making, by tying requirements to design attributes and providing safety considerations prior to system or software design.

### Dual Use Purposes

Implementation of generic safety requirements has dual use purposes. If these requirements are integrated with the software engineering process or system engineering process, from initial definition of system requirements through final acceptance testing of the fielded system, then defining safety requirements in top-level specifications ensures flow-down from top-level requirements and facilitates traceability of safety requirements. If the system under analysis did not have safety designed into the system during early phase engineering with the system or software development process, the requirements and guidelines may be used as an audit tool to determine the level of compliance with the generic requirements and guidelines. Compliance can be validated through analysis, inspection, demonstration, or test. The safety analyst is responsible for conducting a safety risk assessment to quantify any safety risk incurred based on the partial or non-compliance results documented in the hazard tracking system. The Imposed Generic Requirements report facilitates the documentation of full compliance, partial compliance, or non-compliance in the model-based environment. Steps 15 and 16 in the iterative and collaborative model-based process outlined in FIG. 4 correspond to the documentation of compliance or hazard tracking follow on steps.

Enhanced Communication with Stakeholders

Flawed communication is a threat to the successful development of safety significant elements. The challenge in communication between experts in different fields can be heightened due to gaps in assumed knowledge, vocabulary, and understanding. We demonstrate that the approach combines generic requirements, design, compliance evidence, and a collaboration process within the model-based environment. Relevant information is not hidden anymore, as it is the case in a document-based approach. Moreover, the data availability and integration delays observed in the document-based environment are reduced. This corroborates with results presented by Biggs et. al (2014) who investigated the design of a profile to support greater consistency between safety information and system design information to meet the goal of communicating that information to stakeholders.

There were considerations made to assess algorithm design issues and corresponding responses to the probability of failure including committing a Type III or Type IV error. Solving the wrong problem is defined as a Type III error where the systems analysis approach could be conducted from beginning to end and reach a solution that does not address the problem identified. Countermeasures to this error included properly bounding the system problem scope. Type IV system error is a philosophical divergence, and this type of error has chances to surface during assessment of alternatives to solve the system problem in the context of digital engineering. Multiple conversations with subject matter experts mitigated this type of error by leading to the common understanding that the “what” is not changing, but rather the “how” is examined using a different perspective. The case explored in this research project is based on known information, and it is noteworthy to acknowledge that there could potentially be a level of uncertainty linked to the unknown.

The present application discloses a requirements diagram and a sequence diagram. The selected modeling tool offers the ability to construct a model-based glossary. The present disclosure uses this capability to include safety specific definitions to establish a supporting infrastructure for collaboration and communication across stakeholders.

Further, textual requirements were sampled from paragraphs and the extraction criteria was set to ‘shall’ statements. The SysML requirements diagram at a minimum requires critical specifications of name, text, and ID, which allows the model-based blueprint to provide a draft schema of how the applicants designed the algorithm in the modeling environment. The benefits of this are threefold. First, the model lists the requirements in single sentence statements. Second, the model verifies that each requirement is concise, complete, and non-ambiguous. Third, the model identifies and inserts a list of definitions related to safety to facilitate collaboration and adjudication. Transposing requirements from paragraphs to SysML format dictated the breakdown of each paragraph into single sentences. The model provides a nested requirements property to maintain relationships where multiple requirements are listed in the same category.

Another embodiment of the method as applied to Track Data Adapter (TDA) is disclosed. TDA is a new microservice designed for an integrated combat system. A microservice is an architectural and organizational approach to software development where software is composed of small independent services that communicate over well-defined application programming interfaces (API). The inputs include a database of generic software safety requirements from the joint software system safety engineering handbook. The smart packages used these words to filter the database: fault, throughput, latency, timing, integration. These words were based on safety concerns related to the microservice architecture pattern. The model filters and matches the software safety requirements that are deemed appropriate for TDA. Imposed requirements were adjudicated with lead systems engineers. The agreed upon list of applicable requirements were incorporated into the design of TDA. One result of the application of the method was that one of the generic requirements that was identified was the need to design a firewall that prevents data from moving from the virtual sandbox environment to the tactical environment. This firewall would ensure isolation between the tactical environment and the virtual sandbox environment. Without this firewall design, there could be dangers related to the wrong data moving into the tactical environment, and causing weapon systems using this wrong data and possibly firing on the wrong target. This generic requirement was implemented in the design. Software safety approach and analysis results were briefed to safety review boards in June and November 2023 resulting in the approval for install of the software application aboard a naval vessel. This was first time a combat system received deployment concurrence for a fully virtualized weapon system.

An embodiment of the new method provides an algorithm 1) to execute the system safety tasks of receiving a system or software design information; 2) receiving a list of generic safety requirements from one or more several agencies and institutions that have published lists of generic safety requirements for consideration; 3) supporting design decision making; 4) by tying requirements to design attributes and providing safety considerations prior to system or software design; 5) facilitating the documentation of full compliance, partial compliance, or non-compliance; and 6) optimizing the list of generic safety requirements, traced to software and system design and reference standards in a Model-Based Systems engineering environment (MBSE).

Benefits of the of the present disclosure using a modeling tool include: allows to filter standards or guidelines for each component; results in generic requirements to embed in the overarching military design that control multiple interconnected components; reduces human error; reduces duplication-provides single source of information for generic requirements associated to the intended design; supports improved communication and understanding of source of requirement(s) [during the adjudication phase]; and enable verification methods to be specified early [during the adjudication phase].

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 shows a method describing the current state of the art;

FIG. 2 shows a generic safety requirements profile containment tree;

FIG. 3 provides an overview of the process and represents the sequence of activities from both the system design and safety perspectives;

FIG. 4 illustrates the transposition of paragraph-based requirements in textual SysML format;

FIGS. 5 and 6 illustrate safety reports of applicable generic requirements dependency matrix and imposed generic requirements, respectively;

FIG. 7 shows a custom stereotype created with a safety extension generalization;

FIG. 8 shows a method to embed generic safety requirements;

FIG. 9A shows a method to embed generic safety requirements that includes the modeling tool;

FIG. 9B an embodiment of the modeling tool;

FIG. 9C is an example of the inputs 71, 77 and outputs

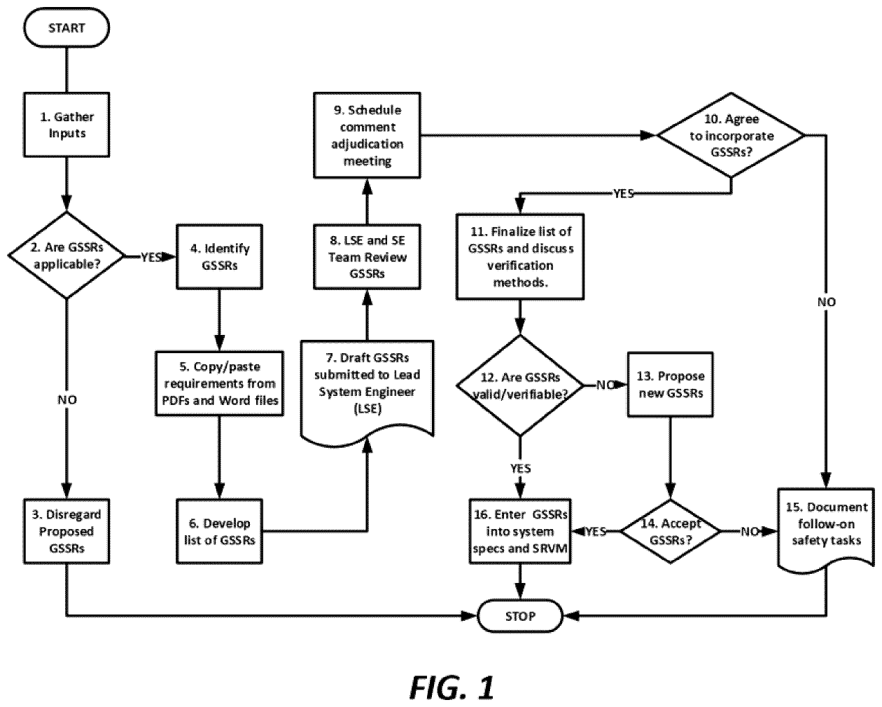

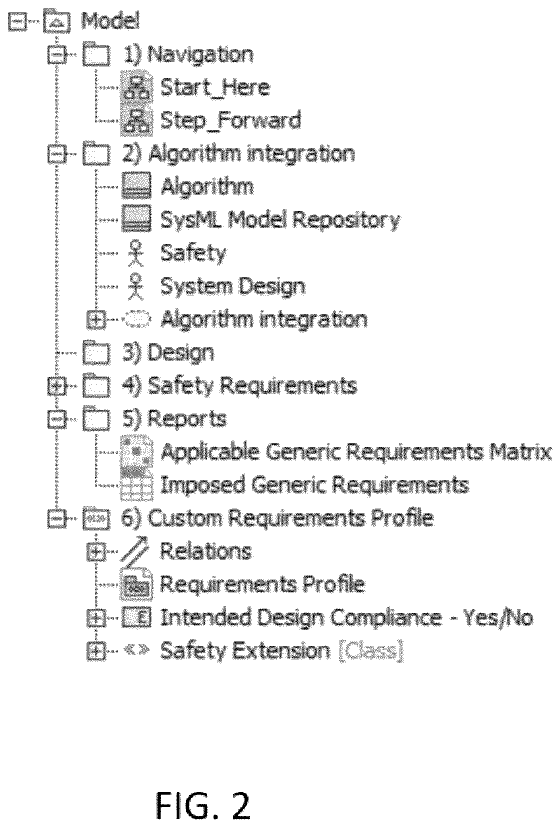

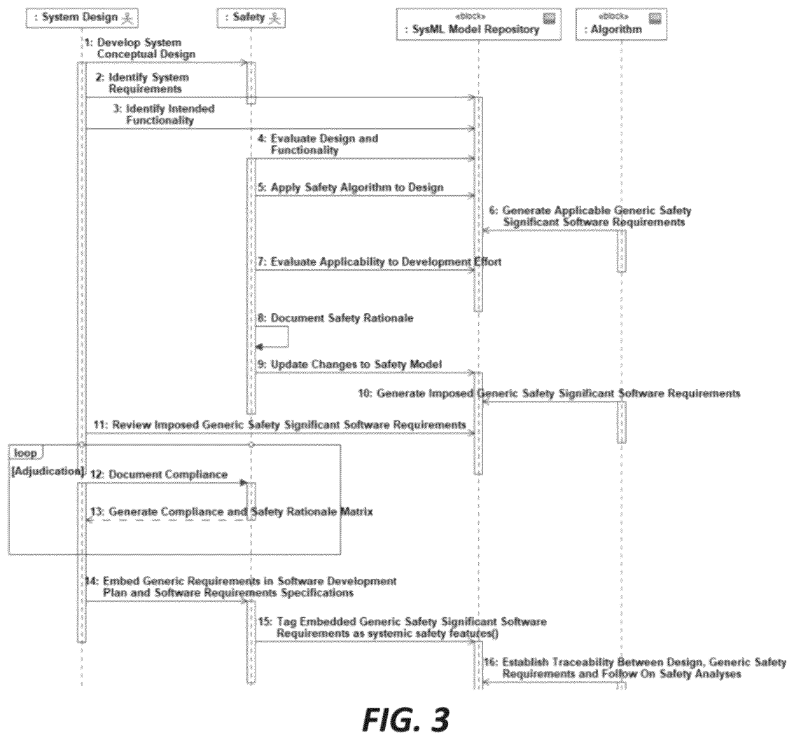

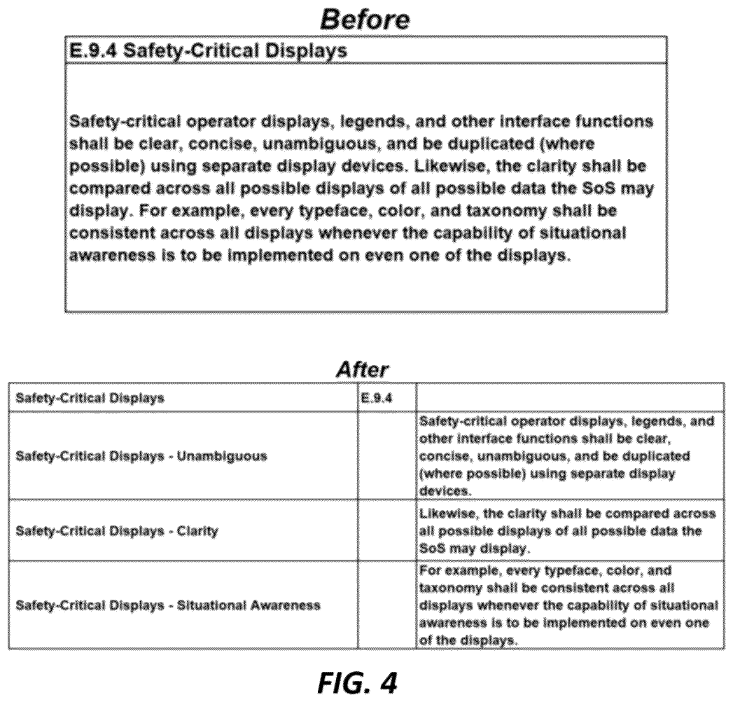

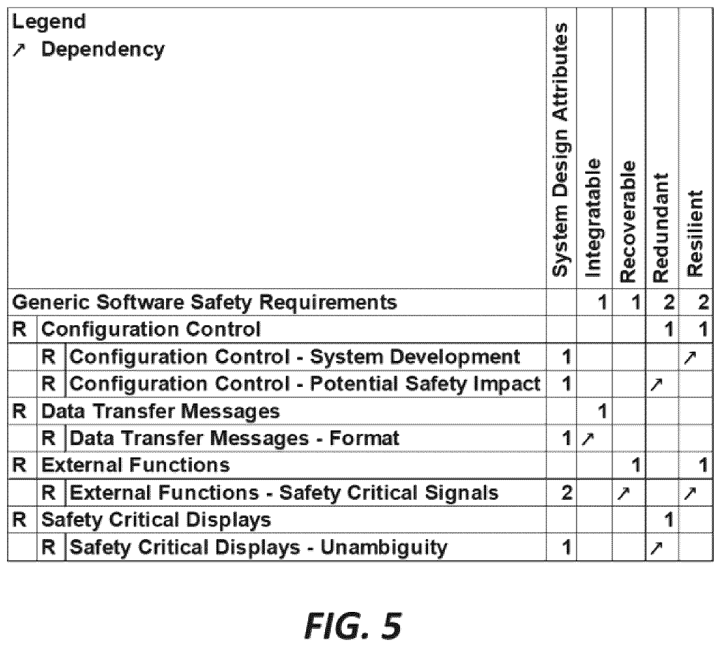

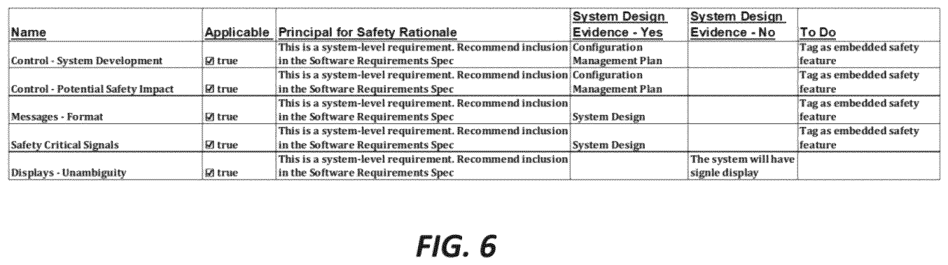

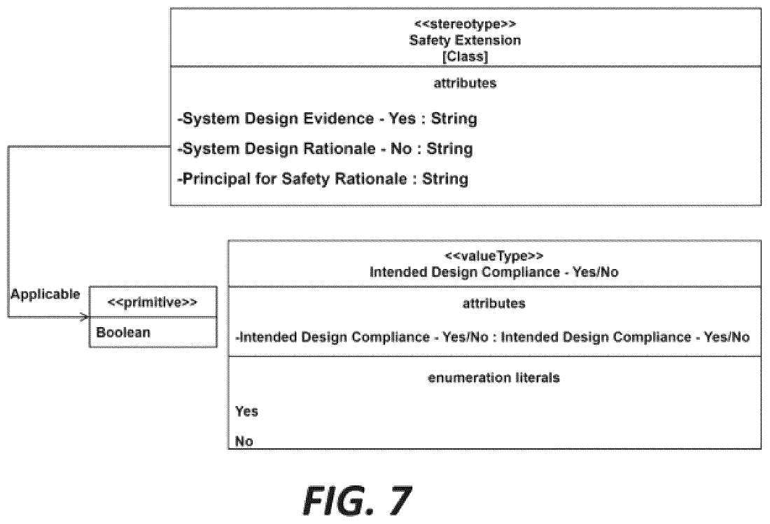

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

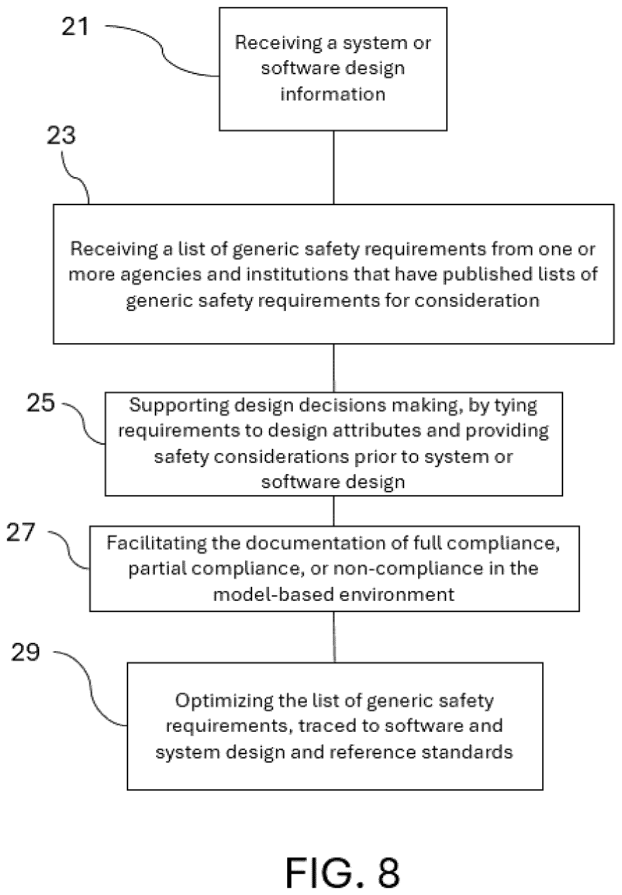

FIG. 8 shows a method to embed generic safety requirements. In block 21, the algorithm receives a system or software design information. In block 23, the algorithm receives a list of generic safety requirements from one or more agencies and institutions that have published lists of generic safety requirements for consideration. In block 25, the algorithm supports the design decisions making, by tying requirements to design attributes and providing safety considerations prior to system or software design. In block 27, the algorithm facilitates the documentation of full compliance, partial compliance, or non-compliance in the model-based environment. In block 29, the algorithm optimizes the list of generic safety requirements, traced to software and system design and reference standards.

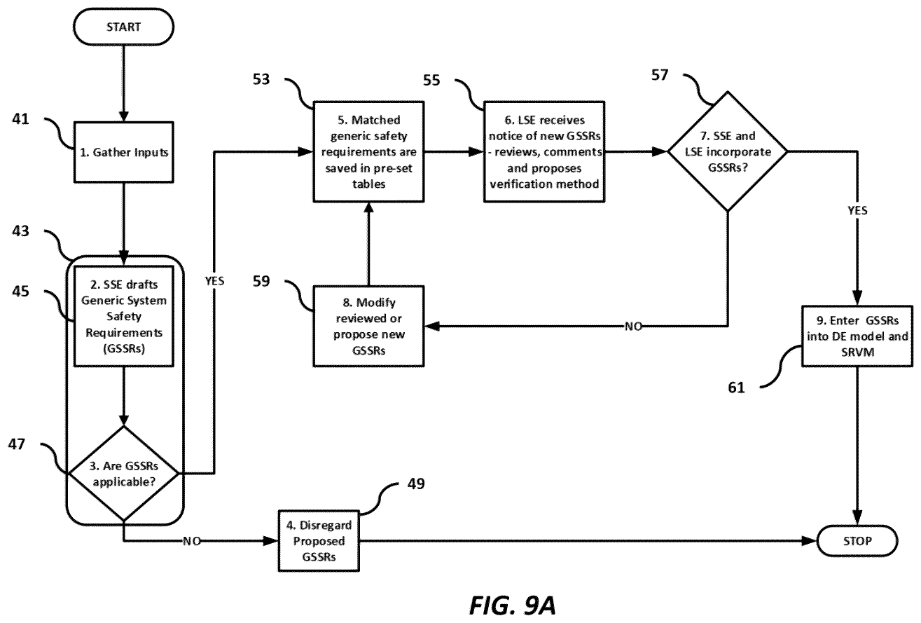

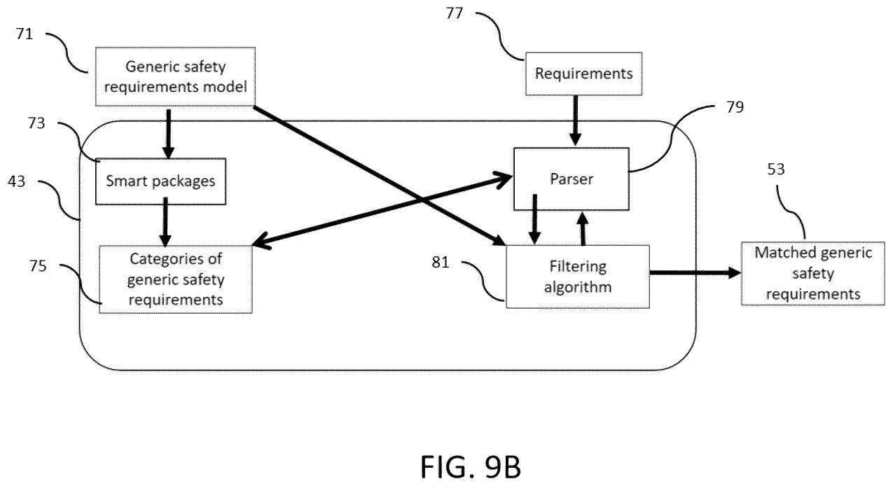

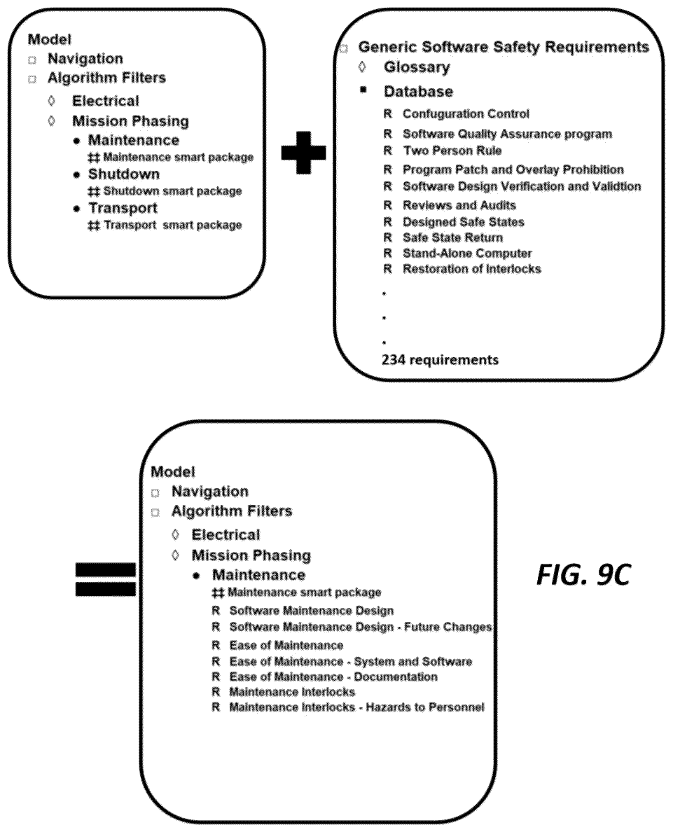

FIG. 9A shows a method to embed generic safety requirements that includes the modeling tool. In block 41, the method gathers inputs. The method gathers these inputs from a variety of sources such as relevant military and commercial specifications, standards, and handbooks. These inputs include known requirements, hazards, capabilities. Block 43 represents the modeling tool (FIG. 9B shows more detail of the modeling tool). In block 45, the System Safety Engineer (SSE) drafts a Generic System Safety Requirements (GSSRs). In block 47, the method determines if the GSSRs are applicable. In block 49, the method disregards GSSRs that are not applicable. In block 53, the method matched GSSRs are saved in pre-set tables. In block 55, the Lead System Engineer (LSE) receives notice of new GSSRs. The LSE reviews, comments, and proposes verification methods. In block 57, the SSE and LSE determine whether the GSSRs should be incorporated. In block 59, the SSE and LSE modify reviewed or proposed GSSRs that were not incorporated. The SSE and LSE then resubmit the modified or proposed new GSSRs to block 53. In block 61, the SSE and LSE enter the GSSRs incorporated in block 57 into the Digital Engineering (DE) model and Safety Requirements Verification Matrix (SRVM). The method's outputs include 1) Input to safety requirements hazard analysis worksheet and safety verification matrix; 2) Updated GSSR compliance matrix; 3) Inputs to lowest level requirements documents; 4) Updated design safety precepts; 5) Updated safety review board technical data package input.

FIG. 9B is an embodiment of the modeling tool 43. In block 71, the elements of the generic safety requirements model are gathered. In block 73, the tool uses the generic safety requirements model to develop smart packages. In block 75, the tool uses the smart packages to develop categories of generic safety requirements. In block 77, requirements for the specific application are gathered. In block 79, the tool parses the specific requirements from block 77 and the categories of generic safety requirements from block 75. In block 81, the tool applies a filtering algorithm to the Generic safety requirements model from block 71 and the parsed requirements from block 79. Then, the algorithm delivers the filtered requirements to block 53 of FIG. 9A.

FIG. 9C is an example of the inputs 71, 77 and outputs 91 of the tool. The input 71 is a model that includes information about subjects such as Navigation, Electrical, Mission Phasing, Physiological, among others. The input 77 is a database of Generic Software Safety Requirements. Output 91 shows the system model requirements as filtered by the Generic System Safety requirements.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method for enhancing safety requirement identification in system and software design, the tool comprising:
constructing a generic system safety requirements (GSSR) model mapping at least one safety stereotype object based on safety hazards in at least one safety smart package;
generating at least one category of generic safety requirements;
receiving at least one system and/or software requirement;
parsing the system and/or software requirement based on the at least one category of generic safety requirements;
filtering a generic system safety requirement based on the parsed system and/or software requirements and the at least one safety stereotype object; and
generating a matched generic safety requirement in pre-set tables.

2. The method of claim 1, wherein the system and/or software requirements may include at least one of known capabilities, relevant military and commercial specifications, standards, and handbooks.

3. The method of claim 1, wherein the generic system safety requirements model is constructed using a general purpose modeling language.

4. The method of claim 3, wherein the general purpose modeling language is Systems Modeling Language (SysML).

5. The method of claim 4, wherein the safety stereotype object is a safety extension generalization, to include the variables of value type string, value type Boolean and value type enumeration literals.

6. The method of claim 1, wherein the safety stereotype object is a domain specific identifier with safety extensions and is constructed as a standalone agnostic, portable, and reusable safety stereotype.

7. The method of claim 1, wherein the safety stereotype object includes a stereotype attribute, a stereotype property and a stereotype tag.

8. The method of claim 1, wherein the at least one system and/or software requirement are received as paragraph-based text and transposed into tabular form.

9. The method of claim 1, wherein the generic software safety requirements are derived from a joint software system safety engineering handbook.

10. The method according to claim 1, wherein the method is a computer program product, comprising a non-transitory computer readable hardware storage device having computer readable program code stored therein, the program code executable by a processor of a computer system.

11. A modeling tool for analyzing system safety requirements, the tool comprising:
parsing a plurality system and/or software specific requirements; and
filtering the plurality system and/or software specific requirements using a generic system safety requirements (GSSR) model to generate a matched generic safety requirement in pre-set tables.

12. The method of claim 11, further comprising:
extracting at least one safety stereotype object from the generic system safety requirements (GSSR) model;
developing a plurality of categories of generic safety requirements; and
using the categories of generic safety requirements to parse the plurality system and/or software specific requirements.

13. The method of claim 12, wherein each safety stereotype is based on a safety smart package in the modeling tool.

14. The tool of claim 11, wherein the tool is a computer program product, comprising a non-transitory computer readable hardware storage device having computer readable program code stored therein, the program code executable by a processor of a computer system.

15. A modeling tool for enhancing safety requirement identification in system and software design for a microservice, the tool comprising:
parsing a plurality of microservice requirements; and
filtering the plurality microservice requirements using a generic system safety requirements (GSSR) model mapping a software system safety engineering handbook to generate a matched generic safety requirement in pre-set tables.

16. The tool of claim 15, further comprising:
extracting at least one safety stereotype object from the generic system safety requirements (GSSR) model;
developing a plurality of categories of generic safety requirements; and
using the categories of generic safety requirements to parse the plurality of microservice requirements.

17. The tool of claim 15, wherein the tool is a computer program product, comprising a non-transitory computer readable hardware storage device having computer readable program code stored therein, the program code executable by a processor of a computer system.
